(19) United States
(12) Patent Application Publication
(10) Pub. No.: US 2008/0110414 A1
(43) Pub. Date: May 15, 2008

(54) MULTI-FUNCTIONAL ANIMAL GARMENT THAT REACTS TO CHANGING TEMPERATURES AND ACTIVITIES

(76) Inventor: Jan Antoinette Buehner, Canistota, SD (US)

Correspondence Address: SCHWEGMAN, LUNDBERG & WOESSNER, P.A., P.O. BOX 2938, MINNEAPOLIS, MN, 55402, US

(21) Appl. No.: 11/936,557

(22) Filed: Nov. 7, 2007

Related U.S. Application Data
(60) Provisional application No. 60/857,426, filed on Nov. 7, 2006.

(51) Int. Cl. A01K 13/00; A01K 15/02; B68C 5/00

(52) U.S. Cl. 119/712; 119/850; 119/859; 54/66

(57) ABSTRACT

An animal garment includes a first layer of temperature controlling fabric which reacts to changing temperatures, and an second layer of heat retaining and releasing fabric. The first layer of temperature controlling fabric includes a polymer structure that closes to retain the heat and opens to release heat and moisture. The second layer of heat retaining and releasing fabric includes molecules which change phase.

### RELATED APPLICATION

This application claims the benefit of U.S. Provisional Application Ser. No. 60/857,426, filed Nov. 7, 2006 under 35 U.S.C. 119(e).

### BACKGROUND OF THE INVENTION

This invention relates to pet garments commonly used for dogs and horses. More particularly, it relates to pet vests or pet clothing that utilizes nanotechnology smart fabric textiles that provide enhanced pet comfort and safety.

Pet vests or animal vests are well known. They include vests that warm or cool the pet, vests that are waterproof and buoyant, and vests that serve as chest protectors.

All the aforementioned pet or animal vests tend to work in separate, specialized areas. More than one vest would need to be used in order to have versatility for a pet or animal.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures, and:

FIG. 1 is the main fabric structure of the pet garment showing the science technology of the fabric reacting to cold or low activity, according to an example embodiment.

FIG. 2 is the main fabric structure of the garment showing the science technology of the fabric reacting to warm or high activity, according to an example embodiment.

FIG. 3 is the isometric view structure of the animal vest, according to an example embodiment.

FIG. 4 is the side view structure of the animal vest with the specific embodiments including the chest area.

FIG. 5 is a cross section view looking down through the animal vest, according to an example embodiment.

FIG. 6 is a perspective side view of a horse full body garment, according to an example embodiment.

FIG. 7 is a perspective view of a horse saddle pad or upper shoulder vest, according to an example embodiment.

FIG. 8 is the internal cut out view of the saddle pad/vest, according to an example embodiment.

FIG. 9 shows an insert for the pocket areas of the vest and garment embodiments described herein, according to an example embodiment.

FIG. 10 illustrates the science and technology of the PCM microcapsules, found in PCM fabric, as they react to changes in temperature, according to an example embodiment.

FIG. 11 is the structural side view of the three dimensional ventilated fabric in the horse pad shoulder garment.

### DESCRIPTION OF THE SPECIFIC EMBODIMENTS

For a better understanding of the invention, we turn now to the drawings. In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, changes may be made without departing from the scope of the present invention. The following description is, therefore, not to be taken in a limited sense, and the scope of the present invention is defined by the appended claims.

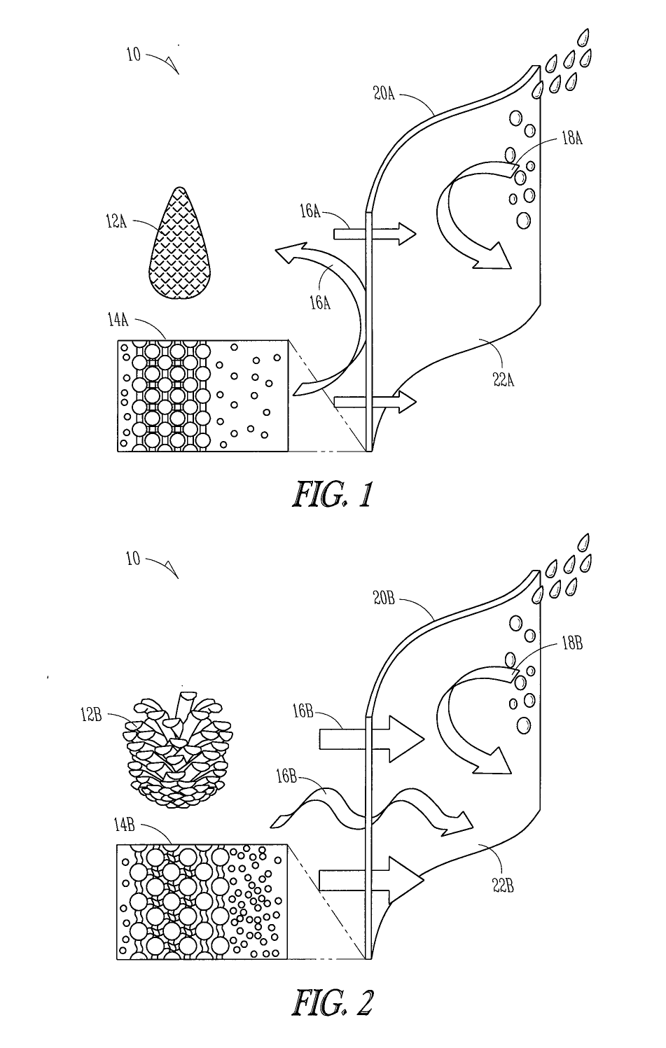

FIG. 1 shows a fabric structure of the pet or animal garment showing the technology of the fabric reacting to cold or low activity, according to an example embodiment. The pet or animal garment includes at least one layer 10 of a temperature controlling fabric or membrane. In one example embodiment, one such temperature controlling layer or membrane 10 changes shape based on different temperature levels, activity levels and the like. The shape of the fabric also changes based on the level of moisture being produced or repelled. The fabric or membrane 10 is available from Schoeller, Textil AG, Sevelen Switzerland under the brand name c_change. The c_change fabric reacts to changes in temperature in a similar manner as pine cones act in nature. In nature, a pine cone 12a reacts to cold temperatures by tightening or closing up the structure of the pine cone. The layer or membrane, similar to a pine cone, reacts to cold temperatures or low activity by closing. Similarly, the temperature controlling fabric layer or membrane has a polymer structure which closes like the pine cone in response to cold temperatures or low activity.

FIG. 1 is a comparison that shows how pine cones closes 12a in cold weather just as the polymer structure condenses 14a to provide better insulation. A high level of heat retention 16a and moisture vapor permeability 16a combine to create a pleasant body climate. By closing, the layer 10 or membrane of fabric is also water proof and provides durability with respect to the wind 18a. The inside of the fabric includes inherently conductive polymer cells 20a protect the necessary heat from escaping through the fabric. The outer fabric also includes inherently conductive polymer cells 22a protect from wind and water. These cells 22a may also protect from dirt, oil and grease stains, bacteria, and odor. Furthermore, if desired, these cells 22a can be coated with insect repellent or impregnated with a vapor release system in the textile fibers.

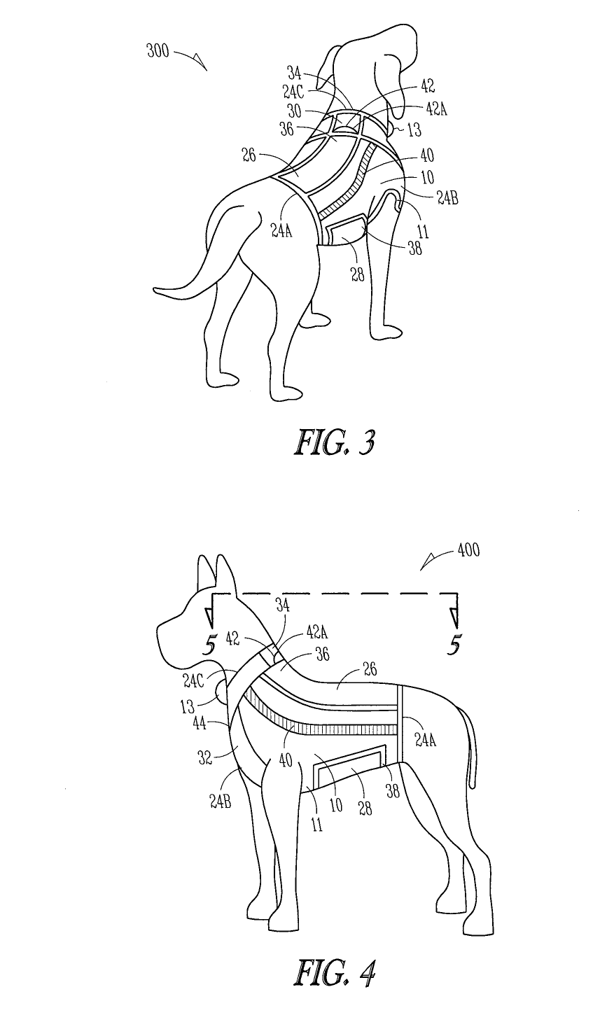

FIG. 2 shows a fabric structure of the pet or animal garment showing the technology of the fabric reacting to warmer temperatures or high levels of activity, according to an example embodiment. Again, the main temperature controlling fabric 10 is compared to a pine cone and how they react in nature 12b to warm or high activity. The comparison shows that pine cones open 12b in warm weather, just as the polymer structure opens up 14b and becomes extremely moisture vapor permeable when presented with warmer temperatures or high activity. When the main temperature controlling fabric has the polymer structures open, excess body heat 16b and moisture 16b can escape to the outside. The fabric or membrane continues to be durable to wind and water proof 18b. The inherently conductive polymer cells 20b on the inside of the fabric 10 are open and release excess heat and moisture through the fabric. Outer fabric inherently inductive polymer cells 22b protect from wind and water. These cells 22b may also protect from dirt, oil and grease stains, bacteria, and odor. If desired, the cells 22b can be coated with insect repellent using a vapor release system.

FIG. 3 is an isometric view of a dog vest, according to an example embodiment. Referring to FIG. 3, the dog vest 300 is made of the main temperature controlling fabric 10. The dog vest 300 includes an underside belly pocket 28, a back pocket 26, a neck pocket 30, and a neck pouch 13. These pockets 13, 26, 28, 30 all contain hook and loop openings to allow for insertion of material or contents and retention of the material or contents within the various pockets. The hook and loop fastening material is also located at a neck portion 34 of the vest 300, a back portion 36 of the vest 300, and a belly portion 38 of the vest 300. A reflective piping for increased visibility is located around the perimeter of the vest 300. In another embodiment, solar materials are integrated into fabric structures or applied as a coating directly onto fabric fibers. These coatings or solar materials harvest the sun's energy to generate power in low light conditions. Such additives and coatings are available from Konarka Technologies, Inc. of Lowell, Mass. USA under the name Powercloth.

More specifically, the reflective piping or power cloth is located at the locations on the vest 300 denoted by reference numbers 24a, 24b, and 24c. A main hook and loop fastening device 40 for dressing and undressing the pet is along the length of the vest 300. More specifically, the hook and loop fastener 40 is positioned along the side of the vest 300 and runs from the neck portion 34 of the vest to the rear of the vest 300. The vest 300 also has an opening 42 therein to allow an existing tab associated with a dog collar to pull through 42. A heavy weight poly tab is also sewn into a seam 42a of the vest 300. The underside of the vest 300 includes a liner 11. The liner, in some embodiments, includes phase change molecules (PCM) which change phase to hold heat and then change phase again to release heat back to the animal. The PCM liner 11 is an additional temperature controlling fabric, set for different temperature ranges, and may be attached or detached with a set of fasteners. In one example embodiment, the set of fasteners includes rust resistant snaps. It should be understood that any type of fastener can be used.

FIG. 4 is an isometric side view of a dog vest 400, according to another example embodiment. Referring to FIG. 4, the vest 400 is formed from a main temperature controlling fabric 10. The vest 400 includes a chest pocket 32, and the hook and loop opening 44. The vest 400 also includes a back pocket 26 with a hook and loop opening 36, a belly underside pocket 28 with an opening 38, and a neck pocket 30 with an opening 34, and a neck pouch 13. The neck pocket 30 also has an opening to accommodate a collar attachment to pull through 42. The vest 400 also includes a heavy weight poly tab sewn in a seam 42a. The main opening for the dog vest 400 includes a hook and loop fastener 40. A secondary temperature controlling liner 11 may be snapped onto the underside of the main temperature controlling fabric for additional heating or cooling effects.

Reflective piping or power cloth surrounds the pet at locations 24a, 24b, 24c, for added safety and visibility.

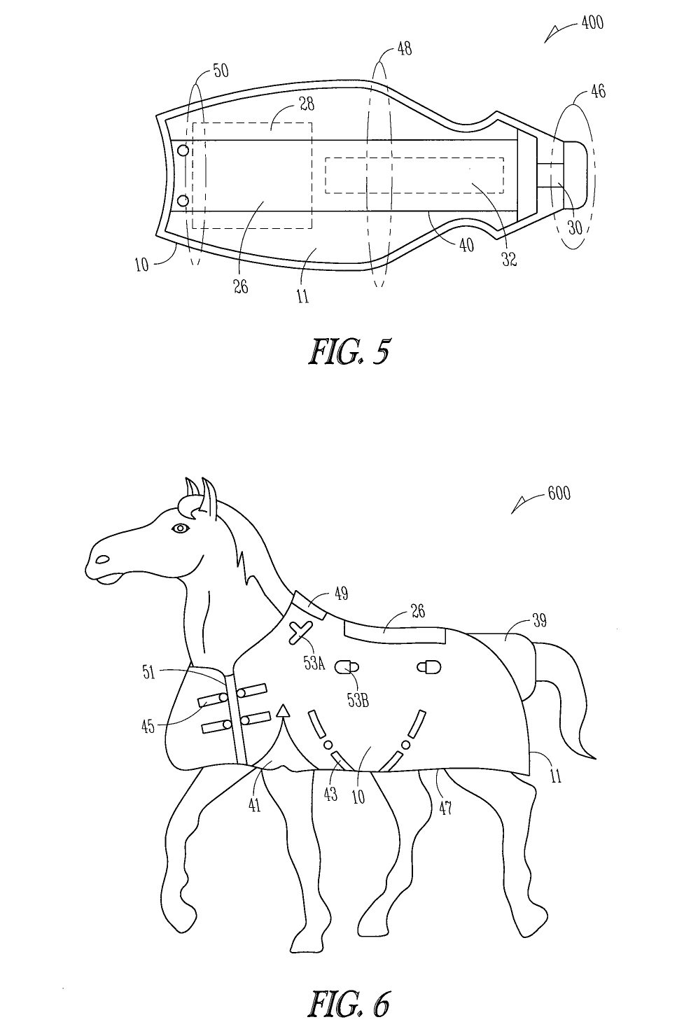

FIG. 5 is a cross section view along line 5-5 in FIG. 4, according to an example embodiment. The cross section view along line 5-5 is a view looking down through the vest 400. Referring to FIG. 5, are the three main circumference areas on the vest 400 which include the neck area 46, the chest area 48, and the stomach area 50. The vest 400 has the neck pocket 30, the chest pocket 32, the underside belly pocket 28, and the back pocket 26. The vest 400 also includes the main hook and loop vest opening 40. Attached to the main outer fabric 10 is an optional secondary temperature controlling liner 11.

FIG. 6 is a perspective side view a garment or cover 600 for a horse that includes the main temperature controlling fabric 10, according to an example embodiment. This main temperature controlling fabric 10 reacts to the horse's body moisture or sweat to open up the polymer structure so that the moisture vapor escapes to the outside. The main temperature controlling fabric 10 is also a membrane which is highly elastic and aids in the horse's high activity level for easy movement and comfort. The fabric offers ultraviolet light (UV) protection to protect the horse from sun bleached hair. The main temperature controlling fabric 10 may also include the addition of a vapor release system (VRS) within the fibers which helps to control mosquitoes, flies and other annoying and health deterring insects. The inner liner 11 also reacts to temperature levels with PCM molecules, set at different temperature reacting levels, which store and release body heat within and to the animal, respectively. This liner 11 is detachable. Different PCM liners 11 can be used in various temperature ranges. For example, one PCM liner may be used on a warm day, and a different PCM liner may be used on a cold day. Sometimes, the liner may be eliminated, and the main temperature controlling fabric 10 would provide the only temperature control. The garment 600 has an open front garment which is secured with double buckles 45 or clip and dee attachments. The garment 600 also includes twin surcingles 43 belly straps that adjust to the size of the horse to keep the garment 600 at a comfortable and safe snug body fit. The garment 600 also includes deep shoulder gussets 41 that allow for freedom of movement. The garment 600 also features adjustable removable leg straps 47 with quick release buckles that add safety while contributing to the body fit of the garment 600. The garment 600 also includes a removable tail flap 39. The tail flap 39 adds additional weather protection and UV protection to the tail area of the horse or animal. The garment 600 also includes a back pocket 26 that has an opening that includes a hook and loop fastener. The opening and back pocket 26 are sized to receive other materials, such as materials that will hold and release heat. The garment 600 also includes a wither protector 49 for added comfort along the horse's mane. A set of D rings 53a attach a hood or neck rug 53b which in turn attaches to an LED light strap for dim or low light conditions or night conditions. The LED light strap makes the horse more visible during low light conditions. A binding or piping 51 is positioned at or along the seams. The binding or piping 51 enhances the looks of the garment 600 and protects the horse from raw edges.

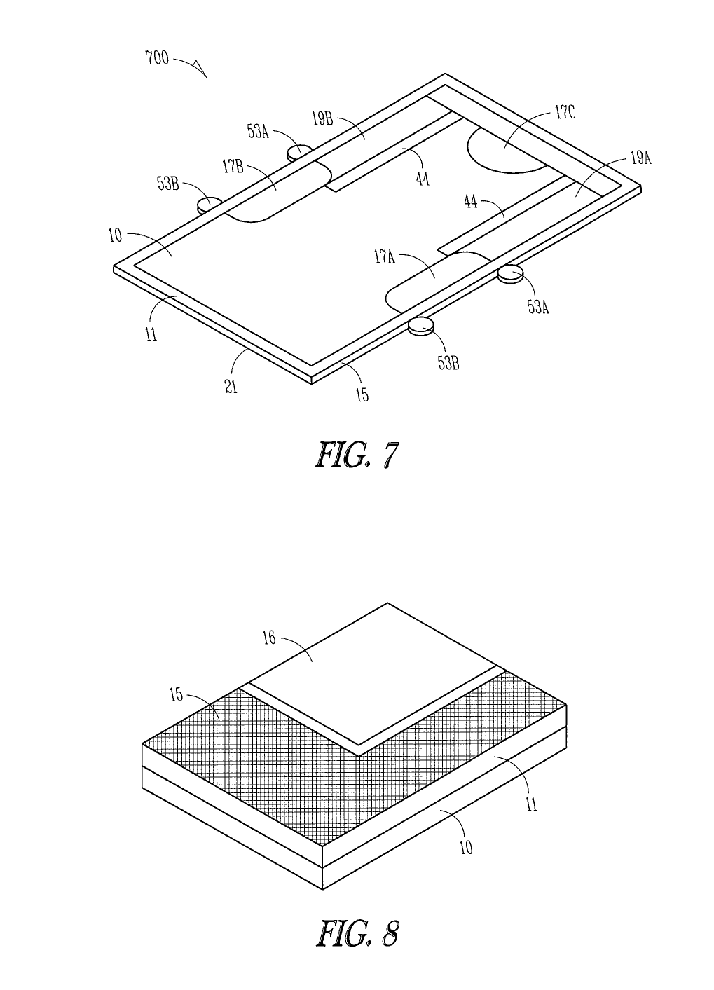

FIG. 7 is a perspective view of a horse saddle pad or upper shoulder vest 700, according to an example embodiment. The horse saddle pad or upper shoulder vest 700 is made from the main temperature controlling fabric 10. In addition to temperature control, the main temperature controlling fabric 10 also protects the animal or horse from rain, wind, dirt, oil, and is anti-abrasive, and anti-microbial. The horse saddle pad or upper shoulder vest 700 can be used in at least two ways. When used as a saddle pad, the horse saddle pad or upper shoulder vest 700 has an inner pad 15 that protects and absorbs saddle shock and reduces spinal pressure. The inner pad 15 also allows air and moisture flow to keep the horse cool. The horse saddle pad or upper shoulder vest 700 also has leather wear plates 17a on the right side 17b on the left side and 17c on a top area, and around the horses wither section. The leather wear plates 17a, 17b protect the pad 700 from wearing down when used with a saddle. It also creates a lack of friction from the motion of the stirrups.

In another embodiment, the lack of friction may also be accomplished with wear plates that are smooth and heavy duty but not necessarily limited to leather. The horse saddle pad or upper shoulder vest 700 also includes pockets 19b, and 19a along the right side, and the left side of the horse, respectively. The pockets, 19a, 19b, close with a hook and loop fastener 44. These pockets 19a, 19b may contain any type of inserts, such as extra padding 15 to adjust to different shoulder widths in horses. The extra padding in the pockets 19a, 19b creates a shim to fit advantage for the horse saddle pad or upper shoulder vest 700. Thus this saddle pad or shoulder vest 700 becomes versatile and may be used with multiple horse sizes. These pockets 19a, 19b may also include a cooling pad such as Soothsoft Chillo comfort device available from Soothsoft Innovations Worldwide, Inc. of Colorado Springs, Colo., USA. This horse saddle pad or upper shoulder vest 700 may be constructed as a square piece, rectangle, or rounded depending on the desired fit. Around the perimeter 21 of the horse saddle pad or upper shoulder vest 700 is a binding or piping to protect and enhance the structure. This pad works under a saddle or as an upper shoulder protection vest with the addition of D rings 53a and 53b to attach straps. The horse saddle pad or upper shoulder vest 700 is used to sooth the horse or animal's tired sore muscles either with a warming device or cooling device inserted into pockets 19a or 19b.

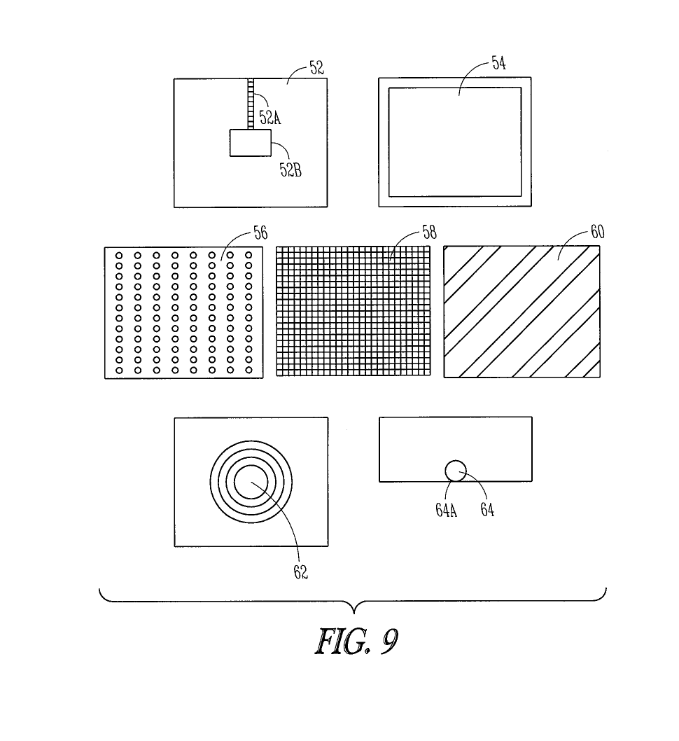

FIG. 8 is the internal cut out view of the saddle pad or upper shoulder vest 700, according to an example embodiment. The internal cut view of the saddle pad or upper shoulder vest 700 shows the layers that form the saddle pad or upper shoulder vest 700. The saddle pad or upper shoulder vest 700 includes a first layer of main temperature controlling fabric 10 and a second layer of main temperature controlling fabric 10′. Sandwiched between the first layer 10 and the second layer 10′ of the of main temperature controlling fabric is a three dimensional spacer fabric 15 and a pad 15. The first layer 10 and the second layer 10′ of the main temperature controlling fabric protect the animal from wind, rain, and dirt. The main temperature controlling fabric 10 and 10′, when treated with an anti-bacterial, provides further protection against bacteria. The second layer of the temperature controlling fabric 10′ has a side that faces the horse's hide or hair. Next to the horse, the membrane 10′ reacts to the horse's moisture and heat development due to activity or temperature level. The water vapor produced by the horse or animal dissipates inside the pad 11 and keeps the horse at a desirable temperature.

The layer of three dimensional spacer fabric 15 contributes to comfort for the horse by diverting saddle shock and relieving pressure points associated with the saddle. The three dimensional spacer fabric 15 also allows airflow and moisture to dissipate. The pad layer 11 between the three dimensional spacer fabric 15 and the second layer 10′ is PCM fabric. When used as a saddle pad, the microcapsules in the PCM fabric 11 will be selected for a temperature range to cool down the horse by absorbing and storing the horse's excess heat. Use as a shoulder protection comfort device without a saddle may vary the temperature setting of the PCM fabric 11. A temperature range can be selected for the PCM fabric 11 to cool down tired muscles or a temperature setting range can be created in the fabric 11 for warmth at the shoulders. In one example embodiment, a combination of fabrics 10, 10′ 11, 15 are all breathable and dissipate heat and moisture. Using the combination of 10 10′ for the outer portions of the pad 700 where the molecular structure opens or closes according to heat and water vapor, and PCM fabric 11 where excess heat is stored and released by microcapsules which have been set to a particular temperature range, will provide the optimal range of comfort for the animal.

FIG. 9 shows an insert for the pocket areas of the vest and garment embodiments described herein, according to an example embodiment. Inserts may be inserted into neck pocket 30, the chest pocket 32, the underside belly pocket 28 and the back pocket 26 of the vest or garment. In some embodiments, the insert is battery-operated and includes a heating and massager pad 52. In one example embodiment, the pad includes a polymer based heating element in fabric which is powered by Lithium-Ion rechargeable battery packs. The polymer based heating element is available from EXO2 of Lanarkshire, United Kingdom, under the brand name FabRoc. The pad 52 may also include a hook and loop opening 52a and an opening for receiving a battery or set of batteries 52b. In some embodiments, the insert is a heat sink cooling pad 54, a floatation panel 5, or an Inherent Conductive Polymer (ICP) shield for protection 58. In still other example embodiments, the insert includes an Inherent Conductive Polymer heating and cooling pad 60. The Inherent Conductive Polymer associated with the pad 60 monitors a pet's or animal's vital signs such as heart rate, respiration and pulse. In still another embodiment, the insert includes a remote control speaker and/or tracker 64 with hook and loop opening 64a. Of course, in some embodiments, a pocket can receive one or more of the various inserts.

FIG. 10 demonstrates how the PCM fabric 11 microcapsules 57 reacts to changing temperatures. When a horse or a dog or another animal's body temperature rises due to increasing activity or outside temperature, the excess heat 59a is transferred into the phase change molecule 57a. The phase change molecules liquefy and store the heat 61a. As the horse or dog cools down 59b, then the phase change molecule 57b solidify or change phase from liquid to solid 61b, and release the stored heat 63 back to the animal. The dog or horse or other animal stays at a more even temperature. This reduces the cycle process of the horse heating up and chilling down.

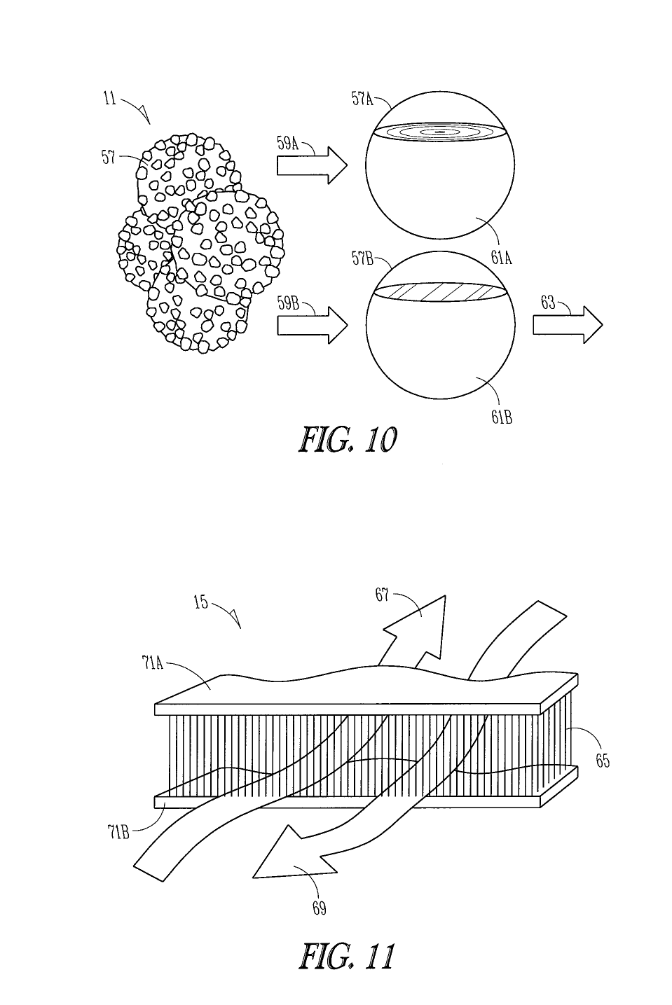

FIG. 11 demonstrates how the three dimensional woven fabric 15 reacts to heat 67 and moisture 69. This knit spacer fabric 15 has a top layer 71a and a bottom layer 71b. In between these layers is a woven spun filament 65 for maximizing compression and recovery, breathability and durability. This fabric does not hold in heat, and, therefore, allows both heat 67 and moisture 69 to flow through the fabric 15. This allows the combination of my three fabric constructions 10, 10′, 11, 15 to work in conjunction together, as in the horse pad, to provide maximum heat and water vapor control along with padded comfort.

These are not the only embodiments of my invention. Alternatively:
The garments may extend further down the leg area or along the back area for more protection and optional heating and cooling for an injured pet. The garments may also utilize a flexible metallic miniature chain-mail fabric designed by the University of Illinois. Uses pressure sensing, and signal processing, which alters the resistance of the conductive fabric clusters. Senses strain while moving, such in horses straining muscles, joints, etc.
The pocket openings may vary in quantity and locations to make insertion and removal easy for various pads.
Different materials, sizes, and interconnections can be used for all components. In lieu of hook-and-loop fasteners 40 along the length of the garment and on the pockets 38, 44, 36 and 34 such as buttons and slips, snaps and hooks. Other connective components may be used and may contribute to the comfort and convenience for the dog or horse or other animal. In such a garment, solar materials are integrated into fabric structures or applied as a coating directly onto fabric fibers. These coatings or solar materials harvest the sun's energy to generate power in low light conditions. Such additives and coatings are available from Konarka Technologies, Inc. of Lowell, Mass. USA under the name Powereloth.
The entire garment may be coated or fibers inherently woven with conductive polymers which protect the pet from insects such as mosquitoes, lice, fleas, ticks and other flying insects such as common house or manure flies.
Both the horse and dog garment may include attached head or face protection made from the same materials. For the dog it would commonly be referred to as a hood with the possibility of an attached visor. For the horse it would commonly be referred to as a neck rug, fly mask, or hood with a cut-out for eyes, ears and mouth or nose area.

Fabrics that combine in variations to be effective for the pet owner's specific needs and adaptability as new smart technologies arise. This may vary depending on an animal's abilities, ranging from simply a house pet, to working animals, such as hunting; seeing eye dogs; K-9 police dogs; and search and rescue dogs. This technology is also applicable to larger size animals, such as horses. The smart fabric will have unobtrusive integration of specialty fibers woven into threads or coated onto the fabric.

The main structure of the garments will include membrane technology which reacts to changing temperatures and activities. This micro-climate activity changes, as necessary, to keep the pet or animal comfortable. In addition it offers heat vapor permeability and is wind and waterproof. It may be non elastic for ease of use for house pet or higher elastic for a working pet or animal. For example, a horse will need a looser fit so as to not restrict the underside or belly area. The working animal or pet needs a tighter fit so it is less apt to snag on outdoor items such as branches, fences, and the like. This also allows freedom of movement and fitting such as a second skin. This main, bionic climate membrane, fabric opens in response to heat or increased activity. At higher body temperatures or during activity, the structure opens as the heat levels rise. This allows the excess heat to escape to the outside air. The opposite occurs during lower level body heat, such as cold weather, or during periods of inactivity. At these other times the structure of the membrane closes, retaining the heat directly to the body surface. Thus shivering or chilling is effectively curtailed or prevented. A vest allows for versatility of use, namely, one pet or animal garment used for all types of weather conditions. It is also versatile since it is effective during active and non active portions of a day. The garment will adapt and does not necessarily need removal. A molecular phase change liner may be attached inside the garment and removed when desired. One liner may be geared to react at a warm temperature range, such as warmer weather or higher activity level. The molecules react as the pet's or animal's temperature rises and acts as an additional cooling agent. Another liner will be available, to react at a specific colder temperature range, when the pet becomes too cold it acts as a warming agent. This will provide an additional membrane that is geared toward temperature and activity changes. It may be snapped on so it is easily attached or detached into the main structure. Outer areas of garment may include attachments for an LED light which will add safer visibility at low light conditions. For increased visibility use of Inherent Conductive Polymer lighted coating, sometimes referred to as power cloth, would increase reflective output.

Pockets will be positioned on the back, underside belly, chest area, and around the neck area. These will add additional functions to the garment to further aid in the comfort of the pet or animal. Different materials may be inserted into these pockets to add versatility and keep costs down. As new smart fabric technologies arise they may be inserted into the smaller pocket areas. This keeps the surface area smaller, retaining main function, and keeping these new technology costs under control.

Pockets on the back of the pet, dog or horse or other animal, have options of holding a battery operated pet temperature control heating pad which uses Far Infrared Rays (FIR). The heating pad may also contain a vibrator or massager for the back and shoulder area. The pocket may also hold a heat sink pad that adds a cool sensation. This is exothermal technology which utilizes alkanes and phase change molecules. These molecules create a longer cooling cycle than can be experienced with ice or gels using the same weight. This technology may also be used for heating, in the case that a pet may be exposed to water and a battery operated heating pad is not feasible. For pets that are near water, ponds, rivers or lakes a floating aid such as a closed cell foam floating panel may be inserted to add buoyancy and reduce stress.

The underside, belly area, and the chest area will contain pockets that may hold a heating device such as a battery operated animal heating pad or a cooling heat sink pad. In addition, this pocket area may hold protection for the under belly or chest area. This shields the pet from snags and other hazards. This material will be tear resistant and rub fast. Fabrics used now include Kevlar; Keprotec; or a more economical fabric such as Dynatec. This material may consist of a woven construction so that an LED light may be illuminated from inside the pocket area. For high protection an open metallized ICP fabric may be used.

The neck pocket is designed for versatility. It may be inserted with a small speaker. The owner wears a small microphone set and can communicate to the pet. This eliminates yelling for the pet when out of reach. A shock collar training device may also be inserted in this neck pocket, which contains a front pouch, and protected from underbrush. This pocket also may open to the dog's collar so the ring can pull thru the material to attach to a leash. Or the owner may use an attached heavy weight poly tab that is sewn into the seam to use as a leash attachment. Any item added to the pocket needs to be as light as possible so not to add additional stress to the animal.

Micro encapsulation technology which allows substances to be added to the fabric will be incorporated into the pet vest. Impregnating silver to the main structure of the vest will help keep the bacterial growth and odor controlled. Dirt, oil and grease stains will be repelled with applied or integrated fiber ICP's. VRS a vapor release system impregnated into textile fibers will act as an insect repellent to control spread of diseases in horses such as West Nile. It will also control flies which should add additional comfort for the horse. Flea and tick control will be especially helpful for pets that are traveling through tall grasses and ground cover. SPT sensory perception technologies may be added to control odors using special fragrance or fresheners along with skin or hair conditioners.

The illustrations and examples provided herein are for explanatory purposes and are not intended to limit the scope of the appended claims, as those skilled in the art will make modifications to the invention for particular uses.

I claim:

1. An animal garment comprising:
a first layer of temperature controlling fabric which reacts to changing temperatures; and
a second layer of heat retaining and releasing fabric.

2. The animal garment of claim 1 wherein the second layer of heat retaining and releasing fabric includes molecules which change phase.

3. The animal garment of claim 1, wherein the first layer of temperature controlling fabric includes a polymer structure that closes to retain the heat and opens to release heat and moisture.

4. The animal garment of claim 1, wherein the first layer of temperature controlling fabric is an outer membrane structure.

5. The animal garment of claim 1 that is substantially waterproof, windproof, anti-microbial, dirt and oil repellent, tear and abrasive resistant.

6. The animal garment of claim 1 that is abrasive resistant.

7. The animal garment of claim 1 that includes an anti-microbial fabric treatment on at least one of the first layer and the second layer.

8. The animal garment of claim 1 that includes a soil repellant fabric treatment on at least one of the first layer and the second layer.

9. The animal garment of claim 2 wherein the second layer of material phase is selected to have molecules which change phase in a selected temperature range.

10. The animal garment of claim 1 further comprising a light reflective portion.

11. The animal garment of claim 1 further comprising an LED light.

12. The animal garment of claim 1, that includes at least one pocket sized to receive an insert.

13. The animal garment of claim 12, wherein the insert includes inherent conductive polymers which can heat and cool the pet.

14. The animal garment of claim 12, wherein the insert includes a battery operated heating and massager device.

15. The animal garment of claim 12, wherein the insert includes a flotation pad.

16. The animal garment of claim 12, wherein the insert includes a GPS tracking device.

17. The animal garment of claim 12, wherein the insert includes a training device.

18. The animal garment of claim 1, that includes portions adapted to protect the animal from UV rays.

19. The animal garment of claim 1, further comprising a fabric for absorbing shock from a saddle.

20. The animal garment of claim 1, further including:
a plurality of shim pockets;
a plurality of padding inserts which may be inserted into at least one of the plurality of shim pockets to accommodate different animal sizes.
